(19) United States
(12) Patent Application Publication
(10) Pub. No.: US 2006/0070273 A1
(43) Pub. Date: Apr. 6, 2006

(54) Show-stand for displaying motion pictures

(75) Inventor: Chack Wah Chan, Hong Kong (CN)

Correspondence Address: Raymond Y Chan, Suite 128, 108 North Ynez Avenue, Monterey Park, CA, 91754, US

(73) Assignee: Visomax Holdings, Ltd., Hong Kong (CN)

(21) Appl. No.: 10/527,420

(22) PCT Filed: Apr. 9, 2003
(86) PCT No.: PCT/CN03/00252

§ 371 Date: Mar. 11, 2005

(30) Foreign Application Priority Data
Sep. 13, 2002 (CN) 02254610.3

(51) Int. Cl. G09F 19/00

(52) U.S. Cl. 40/430; 40/493

(57) ABSTRACT

The present invention provides an operation system for a display framework for motion picture for advertisement and decoration. The display framework includes a base, a bottom frame, a side frame, a picture frame. The operation system is provided between the bottom frame and the bottom of picture, which includes a motor and a transmission unit. The operation is: the motor provides rotational movement to a gearwheel assembly through a transmission unit, then initiates the movement of a control gearwheel, a first direction guiding gearwheel, a second direction guiding gearwheel, a bridging gearwheel, a motion actuating gearwheel, and a motion actuator which undergoes linear reciprocal movement. The motion actuator provides the linear movement of the bottom of picture. It is easy to replace the picture of the display framework of the present invention and both the front and rear sides of the picture frames can be viewed.

### BACKGROUND OF THE PRESENT INVENTION

1. Field of Invention

The present invention relates to a display framework for replaceable motion picture for exhibition, advertisement or decoration.

2. Description of Related Arts

Conventional display framework usually employs a transmission structure which employs the use of an eccentric gearwheel, that the display framework is only capable of showing a single-sided display. This kind of structure is unstable and easily causes jumping movement of the display.

### SUMMARY OF THE PRESENT INVENTION

A main object of the present invention is to provide a display framework for replaceable motion picture which is simple in structure and is highly stable during operation, that the display framework is movable with exchangeable figures and is capable of providing a single-sided or a simultaneous double-sided display.

Accordingly, in order to accomplish the above object, the present invention provides an operation system for a display framework for motion picture comprising a base, a bottom frame, a side frame, a picture frame, a side picture frame and a top picture frame wherein the operation system is provided between the bottom frame and the bottom of picture, the operation system comprising: a motor, a transmission unit connected to the motor, a gearwheel assembly connected to the transmission unit, a control gearwheel connecting to the gearwheel assembly, a first direction guiding gearwheel, a second direction guiding gearwheel, a bridging gearwheel, a motion actuating gearwheel, and a motion actuator connected to the motion actuating gearwheel, wherein the motion actuator, adapted for moving within a predetermined range of angle, is capable of actuating a reciprocal movement of the motion transmitter so as to providing a movement to the bottom of picture, whereby the control gearwheel is driven by the motor and is adjusted to rotate in a predetermined speed through the gearwheel assembly, and when the control gearwheel is engaged with the first direction guiding gearwheel, the motion actuating gearwheel is rotated towards a first direction through the bridging gearwheel such that the motion actuator is moved towards the first direction for moving the bottom of picture through the motion transmitter towards a first corresponding direction, while when the control gearwheel is engaged with the second direction guiding gearwheel, the motion actuating gearwheel is rotated towards a second direction which is opposite to the first direction such that the motion actuator is moved towards the second direction for moving the bottom of picture through the motion transmitter towards a second corresponding direction which is opposite to the first corresponding direction, and when the control gearwheel is in a free rotation condition, a standstill movement of the motion actuator is provided such that a standstill movement of the bottom of picture is provided,

wherein the motor is powered by a direct current (D.C.) power supply or an alternate current (A.C.) power supply,

wherein the motor uses a voltage range between 1.5 and 240V,

wherein the control gearwheel has a range of final rotational speed between 0.5 and 30 per minute,

wherein the control gearwheel comprises a power layer and a motion layer, wherein the power layer has a predetermined of protruded teeth surrounding a circumference of the power layer while the motion layer further divided into an engaging portion and a non-engaging portion that the engaging portion has a predetermined number of protruded teeth surrounding the engaging portion, and

wherein the motion actuator has a rotational range between 20° and 120°.

These and other objectives, features, and advantages of the present invention will become apparent from the following detailed description, the accompanying drawings, and the appended claims.

### BRIEF DESCRIPTION OF THE DRAWINGS

FIG. 1 is a perspective view showing the structural construction of the operation system of the display framework of the present invention according to the preferred embodiment.

FIG. 2 is a perspective view showing the external construction of the operation system of the display framework of the present invention according to the preferred embodiment.

FIG. 3 is a sectional view of the display framework of the present invention of the display framework of the present invention according to the preferred embodiment.

### DETAILED DESCRIPTION OF THE PREFERRED EMBODIMENT

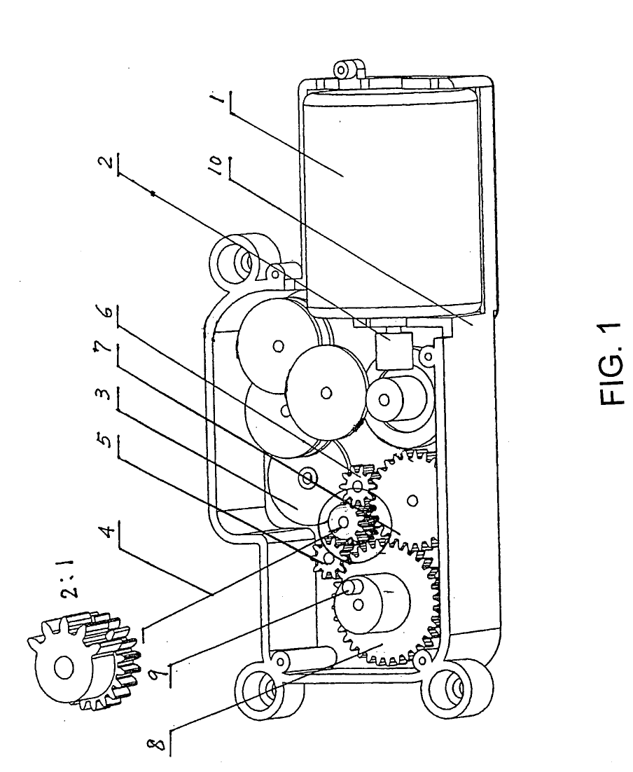

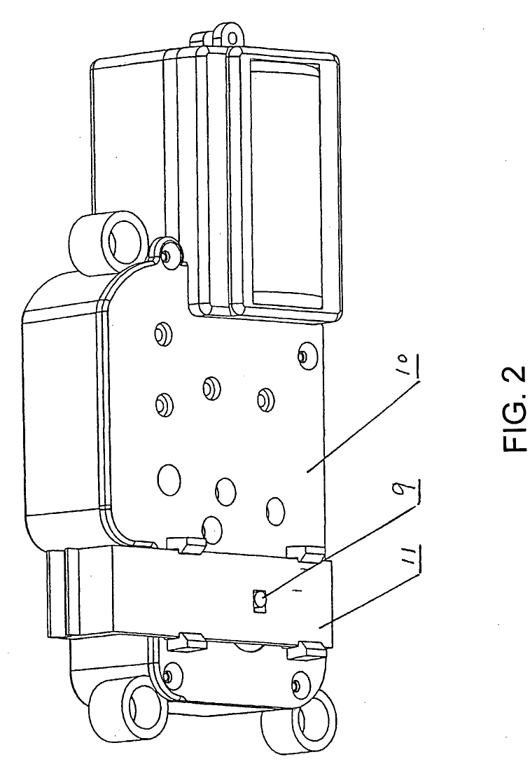

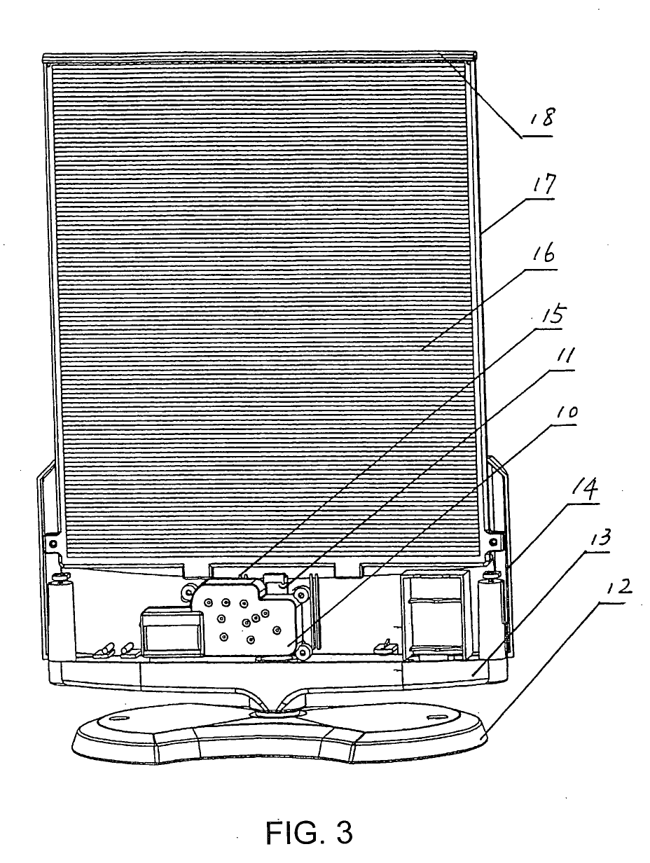

Referring to FIGS. 1 to 3 of the drawings, the present invention provides a display framework comprising a base 12, a bottom frame 13, a side frame 14, a picture frame 16, a side picture frame 17, that a motion picture can be installed from a top side of the picture frame and fixed by a top frame 18. The display framework comprises a bottom picture frame and an operation system 10 positioned between the bottom frame 13 and the bottom of picture 15. The operation system 10 comprises a motor 1, a transmission unit 2, a gearwheel assembly 3 connected to the transmission unit, a control gearwheel 4 connected to the end portion of the gearwheel assembly, a second direction guiding gearwheel 5, a first direction guiding gearwheel 6, a first direction bridging gearwheel 7, a motion actuating gearwheel 8, a motion actuator 9 connected to the motion actuating gearwheel 8 that the movement of the motor actuating gearwheel provides a motion of the motion actuator, a motion transmitter 11 connected to the motion actuator 9 which actuate a generally vertical movement of the motion transmitter 11. The motion transmitter 11 then transmits a generally vertical movement to the bottom of picture that the bottom of picture is moved up and down reciprocity. The motor is 1 may be a DC or an AC motor. According to the preferred embodiment of the display framework of the present invention, the voltage of the motor is between 1.5 and 240V, the control gearwheel driven by the motor is preferably maintained an optimum rotational speed at 0.5-30 revolution per minute. The control gearwheel 4 has a power layer and a motion layer, that a complete teeth set is protruded radially from the power layer and that a partial teeth set is protruded from the motion layer to define an engaging portion and a non-engaging portion. The adjustable range of movement of the motion actuator is between 20° and 120° for determining the pace of the motion of the motion picture. Both the front and rear sides of the display framework can be used for displaying motion pictures. It is easy to replace the motion picture and different interface of the motion picture can be showed. Therefore, in the operation system, the motor provides driving force to the gearwheel assembly through the transmission unit, that the gearwheel assembly adjusts the speed of the end portion of the gearwheel assembly to a predetermined speed, which in turn brings the movement of the control gearwheel. When the control gear wheel engages with the first direction guiding gearwheel which turn the motion actuating gearwheel in a first direction through the first bridging gearwheel, the motion actuator is moved towards the first direction and provide a generally vertical movement of the bottom of picture through the motion transmitter such that the picture frame is moved towards a first corresponding direction. When the control gearwheel engages with the second direction guiding gearwheel which turns the motion actuating gearwheel in a second direction, the motion actuator is moved towards a second direction which is an opposition direction to the first direction, and provide a generally vertical movement of the bottom of picture through the motion transmitter such that the picture frame is moved towards a second corresponding direction. When the non-engaging portion of the motion layer of the control gearwheel is in contact with the first and second direction guiding gearwheel, no movement is induced and that the motion actuator is not actuated. That is to say, the picture frame is operated in two opposite directions reciprocally with an intermediate standstill position.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. An operation system for a display framework for motion picture comprising a base, a bottom frame, a side frame, a picture frame, a side picture frame and a top picture frame wherein said operation system is provided between the bottom frame and the bottom of picture, said operation system comprising: a motor, a transmission unit connected to said motor, a gearwheel assembly connected to said power transmission unit, a control gearwheel connecting to said gearwheel assembly, a first direction guiding gearwheel, a second direction guiding gearwheel, a bridging gearwheel, a motion actuating gearwheel, and a motion actuator connected to said motion actuating gearwheel, wherein said motion actuator, adapted for moving within a predetermined range of angle, is capable of actuating a reciprocal movement of said motion transmitter so as to providing a movement to said bottom picture frame, whereby said control gearwheel is powered by said motor and is adjusted to rotate in a predetermined speed through said gearwheel assembly, and when said control gearwheel is engaged with said first direction guiding gearwheel, said motion actuating gearwheel is rotated towards a first direction through said bridging gearwheel such that said motion actuator is moved towards said first direction for moving said bottom picture frame through said motion transmitter towards a first corresponding direction, while when said control gearwheel is engaged with said second direction guiding gearwheel, said motion actuating gearwheel is rotated towards a second direction which is opposite to said first direction such that said motion actuator is moved towards said second direction for moving said bottom picture frame through said motion transmitter towards a second corresponding direction which is opposite to said first corresponding direction, and when said control gearwheel is in a free rotation condition, a standstill movement of said motion actuator is provided such that a standstill movement of said bottom picture frame is provided.

2. The operation system, as recited in claim 1, wherein said motor is powered by the group consisting of a direct current (D.C.) power supply or a alternate current (A.C.) power supply.

3. The operation system, as recited in claim 1 or 2, wherein said motor has a workable range between 1.5 and 240V.

4. The operation system, as recited in claim 1, 2 or 3, wherein said control gearwheel has final rotational speed between 0.5 and 30 revolution per minute.

5. The operation system, as recited in claim 1, wherein said control gearwheel comprises a power layer and a motion layer, wherein said power layer has a predetermined of protruded teeth surrounding a circumference of said power layer while said motion layer further divided into an engaging portion and a non-engaging portion that said engaging portion has a predetermined number of protruded teeth surrounding said engaging portion.

6. The operation system, as recited in claim 1, wherein said motion actuator has a rotational range between 20° and 120°.
